(19) United States
(12) Patent Application Publication
(10) Pub. No.: US 2019/0166040 A1
(43) Pub. Date: May 30, 2019

(54) AUTOMATIC SCALING OF VPN CONNECTIONS

(71) Applicant: Microsoft Technology Licensing, LLC, Redmond, WA (US)

(72) Inventors: Abhishek K. TIWARI, Woodinville, WA (US); Ashok NANDOORI, Redmond, WA (US); Arpan Kumar ASTHANA, Bothell, WA (US); Mohit GARG, Redmond, WA (US)

(21) Appl. No.: 15/826,135

(22) Filed: Nov. 29, 2017

(51) Int. Cl. H04L 12/707; H04L 29/06; H04L 12/46; H04L 12/26

(52) U.S. Cl. CPC H04L 45/22; H04L 43/0811; H04L 12/4641; H04L 63/0272

(57) ABSTRACT

The disclosed technology may include determining that a change is to be made in virtual private network (VPN) connectivity between a first site and a second site while a first VPN connection is operational between a first device at the first site and a first gateway at the second site. VPN information is provided to a second gateway at the second site, the VPN information including information that is associated with a second VPN connection to be established between the first device and the second gateway. It is detected that network traffic is flowing over the second VPN connection between the first device and the second gateway. In response to detecting that the network traffic is flowing between the first device and the second gateway, a notification is sent to the first gateway for the first gateway to deprovision the first VPN connection.

### BACKGROUND

In some examples, a virtual private network (VPN) effectively extends a private network across a public network, and enables users to communicate across public networks as if their computing devices were directly connected to the private network. A VPN may enable a computing device to exchange data with a private network across a shared or public network, such as the Internet, while benefiting from the functionality, security, and management policies of the private network. A site-to-site VPN connection may combine two networks such that devices in geographically separate locations can share one cohesive private network.

### SUMMARY OF THE DISCLOSURE

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Briefly stated, the disclosed technology is generally directed to virtual private network (VPN) connections. In one example of the technology, it is determined that a change is to be made in VPN connectivity between a first site and a second site while a first VPN connection is operational between a first device at the first site and a first gateway at the second site. In some examples, VPN information is provided to a second gateway at the second site, the VPN information including information that is associated with a second VPN connection to be established between the first device and the second gateway. In some examples, it is detected that network traffic is flowing over the second VPN connection between the first device and the second gateway. In some examples, in response to detecting that the network traffic is flowing between the first device and the second gateway, a notification is sent to the first gateway for the first gateway to deprovision the first VPN connection.

Other aspects of and applications for the disclosed technology will be appreciated upon reading and understanding the attached figures and description.

### BRIEF DESCRIPTION OF THE DRAWINGS

Non-limiting and non-exhaustive examples of the present disclosure are described with reference to the following drawings. In the drawings, like reference numerals refer to like parts throughout the various figures unless otherwise specified. These drawings are not necessarily drawn to scale.

For a better understanding of the present disclosure, reference will be made to the following Detailed Description, which is to be read in association with the accompanying drawings, in which:

FIG. 1 is a block diagram illustrating one example of a suitable environment in which aspects of the technology may be employed;

FIG. 2 is a block diagram illustrating one example of a suitable computing device according to aspects of the disclosed technology;

FIG. 3 is a block diagram illustrating an example of a system;

FIG. 4 shows a logical flow diagram illustrating an example of a process that may be employed by an example of the gateway manager of FIG. 3; and

FIGS. 5A-5B show a logical flow diagram illustrating an example of a process that may be employed by an example of the gateway manager of FIG. 3, in accordance with aspects of the present disclosure.

### DETAILED DESCRIPTION

The following description provides specific details for a thorough understanding of, and enabling description for, various examples of the technology. One skilled in the art will understand that the technology may be practiced without many of these details. In some instances, well-known structures and functions have not been shown or described in detail to avoid unnecessarily obscuring the description of examples of the technology. It is intended that the terminology used in this disclosure be interpreted in its broadest reasonable manner, even though it is being used in conjunction with a detailed description of certain examples of the technology. Although certain terms may be emphasized below, any terminology intended to be interpreted in any restricted manner will be overtly and specifically defined as such in this Detailed Description section. Throughout the specification and claims, the following terms take at least the meanings explicitly associated herein, unless the context dictates otherwise. The meanings identified below do not necessarily limit the terms, but merely provide illustrative examples for the terms. For example, each of the terms “based on” and “based upon” is not exclusive, and is equivalent to the term “based, at least in part, on”, and includes the option of being based on additional factors, some of which may not be described herein. As another example, the term “via” is not exclusive, and is equivalent to the term “via, at least in part”, and includes the option of being via additional factors, some of which may not be described herein. The meaning of “in” includes “in” and “on.” The phrase “in one embodiment,” or “in one example,” as used herein does not necessarily refer to the same embodiment or example, although it may. Use of particular textual numeric designators does not imply the existence of lesser-valued numerical designators. For example, reciting “a widget selected from the group consisting of a third foo and a fourth bar” would not itself imply that there are at least three foo, nor that there are at least four bar, elements. References in the singular are made merely for clarity of reading and include plural references unless plural references are specifically excluded. The term “or” is an inclusive “or” operator unless specifically indicated otherwise. For example, the phrases “A or B” means “A, B, or A and B.” As used herein, the terms “component” and “system” are intended to encompass hardware, software, or various combinations of hardware and software. Accordingly, for example, a system or component may be a process, a process executing on a computing device, the computing device, or a portion thereof.

### INTRODUCTION

Briefly stated, the disclosed technology is generally directed to virtual private network (VPN) connections. In one example of the technology, it is determined that a change is to be made in VPN connectivity between a first site and a second site while a first VPN connection is operational between a first device at the first site and a first gateway at the second site. In some examples, VPN information is provided to a second gateway at the second site, the VPN information including information that is associated with a second VPN connection to be established between the first device and the second gateway. In some examples, it is detected that network traffic is flowing over the second VPN connection between the first device and the second gateway. In some examples, in response to detecting that the network traffic is flowing between the first device and the second gateway, a notification is sent to the first gateway for the first gateway to deprovision the first VPN connection.

In a large public cloud deployment, a particular site-to-site VPN connection may be moved from one gateway to another for any of a variety of different reasons. A new VPN connection may be established to another gateway while temporarily maintaining the original gateway connection. While both gateway connections are running, traffic may be divided into two paths, one for the original gateway connection, and another for the new gateway connection. In various examples, the traffic may be divided in any suitable manner, such as via Equal-cost multi-path routing (ECMP), or in any other suitable manner.

In some examples, while the new VPN connection has been established with the original VPN connection still running, network traffic on the new VPN connection is monitored. Responsive to detecting traffic on the new VPN connection, the original VPN connection may be removed. In some examples, after the original VPN connection is removed, the traffic will then be directed to the new VPN connection rather than being divided between the two connections. In this way, in some examples, the new VPN connection is established while ensuring that the remote site remains continuously connected to a VPN gateway, e.g., so that no downtime occurs by switching the VPN connection from one gateway to another.

### Illustrative Devices/Operating Environments

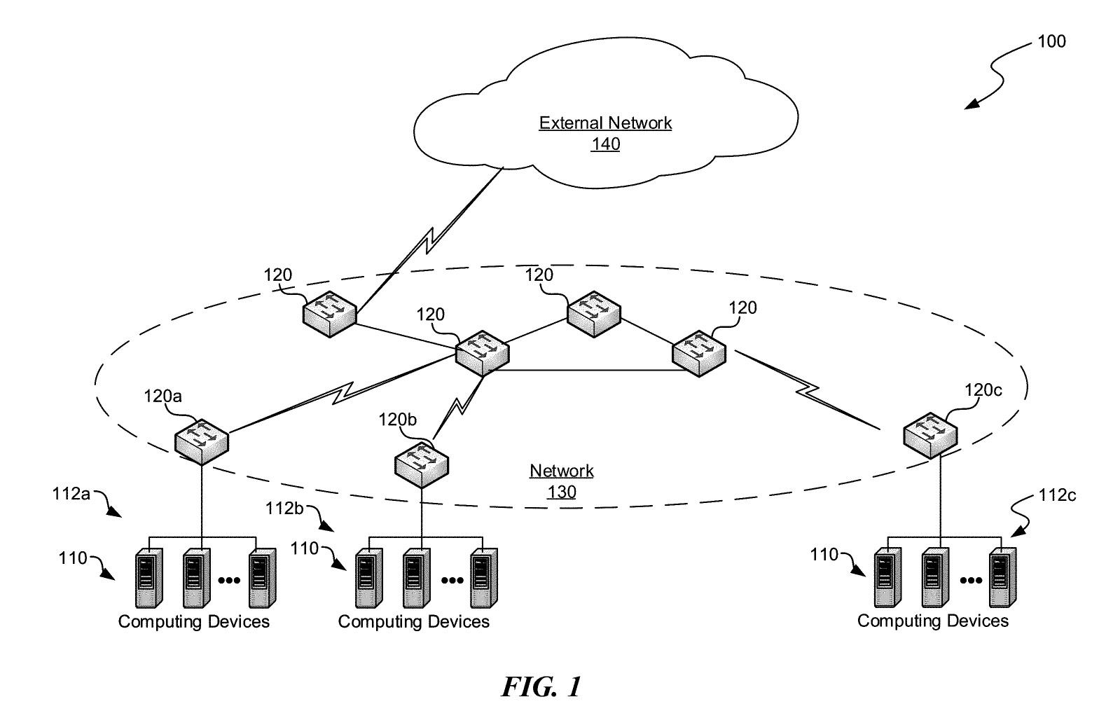

FIG. 1 is a diagram of environment 100 in which aspects of the technology may be practiced. As shown, environment 100 includes computing devices 110, as well as network nodes 120, connected via network 130. Even though particular components of environment Dm are shown in FIG. 1, in other examples, environment Dm can also include additional and/or different components. For example, in certain examples, the environment Dm can also include network storage devices, maintenance managers, and/or other suitable components (not shown).

As shown in FIG. 1, network 130 can include one or more network nodes 120 that interconnect multiple computing devices no, and connect computing devices no to external network 140, e.g., the Internet or an intranet. For example, network nodes 120 may include switches, routers, hubs, network controllers, or other network elements. In certain examples, computing devices no can be organized into racks, action zones, groups, sets, or other suitable divisions. For example, in the illustrated example, computing devices no are grouped into three host sets identified individually as first, second, and third host sets 112a-112c. In the illustrated example, each of host sets 112a-112c is operatively coupled to a corresponding network node 120a-120c, respectively, which are commonly referred to as “top-of-rack” or “TOR” network nodes. TOR network nodes 120a-120c can then be operatively coupled to additional network nodes 120 to form a computer network in a hierarchical, flat, mesh, or other suitable types of topology that allows communication between computing devices no and external network 140. In other examples, multiple host sets 112a-112c may share a single network node 120. Computing devices 110 may be virtually any type of general- or specific-purpose computing device. For example, these computing devices may be user devices such as desktop computers, laptop computers, tablet computers, display devices, cameras, printers, or smartphones. However, in a data center environment, these computing devices may be server devices such as application server computers, virtual computing host computers, or file server computers. Moreover, computing devices 110 may be individually configured to provide computing, storage, and/or other suitable computing services.

### Illustrative Computing Device

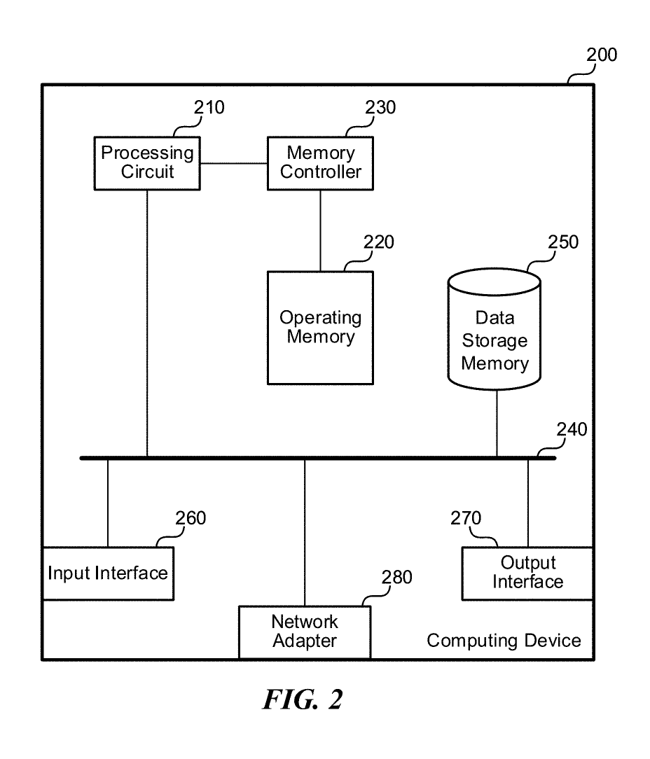

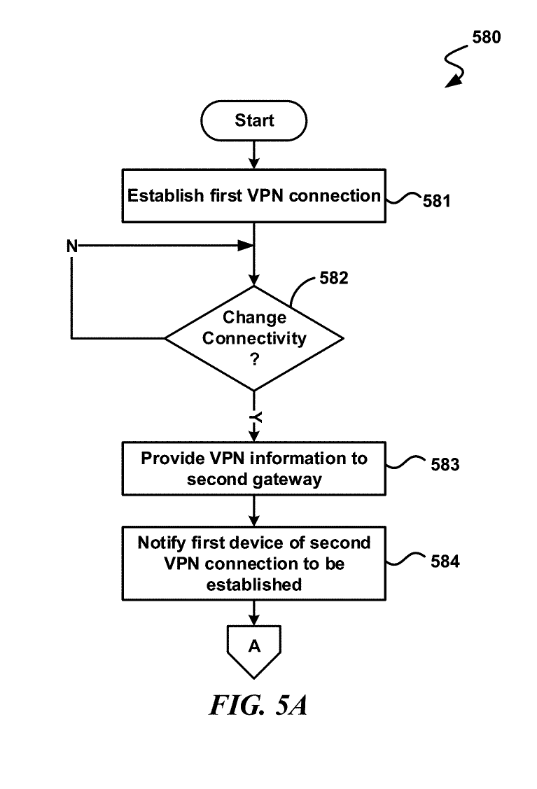

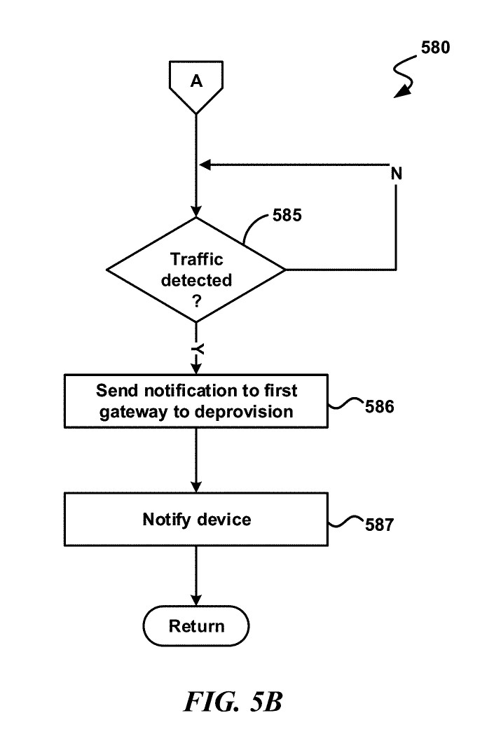

FIG. 2 is a diagram illustrating one example of computing device 200 in which aspects of the technology may be practiced. Computing device 200 may be virtually any type of general- or specific-purpose computing device. For example, computing device 200 may be a user device such as a desktop computer, a laptop computer, a tablet computer, a display device, a camera, a printer, or a smartphone. Likewise, computing device 200 may also be server device such as an application server computer, a virtual computing host computer, or a file server computer, e.g., computing device 200 may be an example of computing device 110 or network node 120 of FIG. 1. Likewise, computer device 200 may be an example any of the devices illustrated in FIG. 5, as discussed in greater detail below. As illustrated in FIG. 2, computing device 200 includes processing circuit 210, operating memory 220, memory controller 230, data storage memory 250, input interface 260, output interface 270, and network adapter 280. Each of these afore-listed components of computing device 200 includes at least one hardware element.

Computing device 200 includes at least one processing circuit 210 configured to execute instructions, such as instructions for implementing the herein-described workloads, processes, or technology. Processing circuit 210 may include a microprocessor, a microcontroller, a graphics processor, a coprocessor, a field programmable gate array, a programmable logic device, a signal processor, or any other circuit suitable for processing data. The aforementioned instructions, along with other data (e.g., datasets, metadata, operating system instructions, etc.), may be stored in operating memory 220 during run-time of computing device 200. Operating memory 220 may also include any of a variety of data storage devices/components, such as volatile memories, semi-volatile memories, random access memories, static memories, caches, buffers, or other media used to store run-time information. In one example, operating memory 220 does not retain information when computing device 200 is powered off. Rather, computing device 200 may be configured to transfer instructions from a non-volatile data storage component (e.g., data storage component 250) to operating memory 220 as part of a booting or other loading process.

Operating memory 220 may include 4^{th} generation double data rate (DDR4) memory, 3^{rd} generation double data rate (DDR3) memory, other dynamic random access memory (DRAM), High Bandwidth Memory (HBM), Hybrid Memory Cube memory, 3D-stacked memory, static random access memory (SRAM), or other memory, and such memory may comprise one or more memory circuits integrated onto a DIMM, SIMM, SODIMM, or other packaging. Such operating memory modules or devices may be organized according to channels, ranks, and banks. For example, operating memory devices may be coupled to processing circuit 210 via memory controller 230 in channels. One example of computing device 200 may include one or two DIMMs per channel, with one or two ranks per channel. Operating memory within a rank may operate with a shared clock, and shared address and command bus. Also, an operating memory device may be organized into several banks where a bank can be thought of as an array addressed by row and column. Based on such an organization of operating memory, physical addresses within the operating memory may be referred to by a tuple of channel, rank, bank, row, and column.

Despite the above-discussion, operating memory 220 specifically does not include or encompass communications media, any communications medium, or any signals per se.

Memory controller 230 is configured to interface processing circuit 210 to operating memory 220. For example, memory controller 230 may be configured to interface commands, addresses, and data between operating memory 220 and processing circuit 210. Memory controller 230 may also be configured to abstract or otherwise manage certain aspects of memory management from or for processing circuit 210. Although memory controller 230 is illustrated as single memory controller separate from processing circuit 210, in other examples, multiple memory controllers may be employed, memory controller(s) may be integrated with operating memory 220, or the like. Further, memory controller(s) may be integrated into processing circuit 210. These and other variations are possible.

In computing device 200, data storage memory 250, input interface 260, output interface 270, and network adapter 280 are interfaced to processing circuit 210 by bus 240. Although, FIG. 2 illustrates bus 240 as a single passive bus, other configurations, such as a collection of buses, a collection of point to point links, an input/output controller, a bridge, other interface circuitry, or any collection thereof may also be suitably employed for interfacing data storage memory 250, input interface 260, output interface 270, or network adapter 280 to processing circuit 210.

In computing device 200, data storage memory 250 is employed for long-term non-volatile data storage. Data storage memory 250 may include any of a variety of non-volatile data storage devices/components, such as non-volatile memories, disks, disk drives, hard drives, solid-state drives, or any other media that can be used for the non-volatile storage of information. However, data storage memory 250 specifically does not include or encompass communications media, any communications medium, or any signals per se. In contrast to operating memory 220, data storage memory 250 is employed by computing device 200 for non-volatile long-term data storage, instead of for run-time data storage.

Also, computing device 200 may include or be coupled to any type of processor-readable media such as processor-readable storage media (e.g., operating memory 220 and data storage memory 250) and communication media (e.g., communication signals and radio waves). While the term processor-readable storage media includes operating memory 220 and data storage memory 250, the term “processor-readable storage medium,” throughout the specification and the claims whether used in the singular or the plural, is defined herein so that the term “processor-readable storage medium” specifically excludes and does not encompass communications media, any communications medium, or any signals per se. However, the term “processor-readable storage medium” does encompass processor cache, Random Access Memory (RAM), register memory, and/or the like.

Computing device 200 also includes input interface 260, which may be configured to enable computing device 200 to receive input from users or from other devices. In addition, computing device 200 includes output interface 270, which may be configured to provide output from computing device 200. In one example, output interface 270 includes a frame buffer, graphics processor, graphics processor or accelerator, and is configured to render displays for presentation on a separate visual display device (such as a monitor, projector, virtual computing client computer, etc.). In another example, output interface 270 includes a visual display device and is configured to render and present displays for viewing.

In the illustrated example, computing device 200 is configured to communicate with other computing devices or entities via network adapter 280. Network adapter 280 may include a wired network adapter, e.g., an Ethernet adapter, a Token Ring adapter, or a Digital Subscriber Line (DSL) adapter. Network adapter 280 may also include a wireless network adapter, for example, a Wi-Fi adapter, a Bluetooth adapter, a ZigBee adapter, a Long-Term Evolution (LTE) adapter, or a 5G adapter.

Although computing device 200 is illustrated with certain components configured in a particular arrangement, these components and arrangement are merely one example of a computing device in which the technology may be employed. In other examples, data storage memory 250, input interface 260, output interface 270, or network adapter 280 may be directly coupled to processing circuit 210, or be coupled to processing circuit 210 via an input/output controller, a bridge, or other interface circuitry. Other variations of the technology are possible.

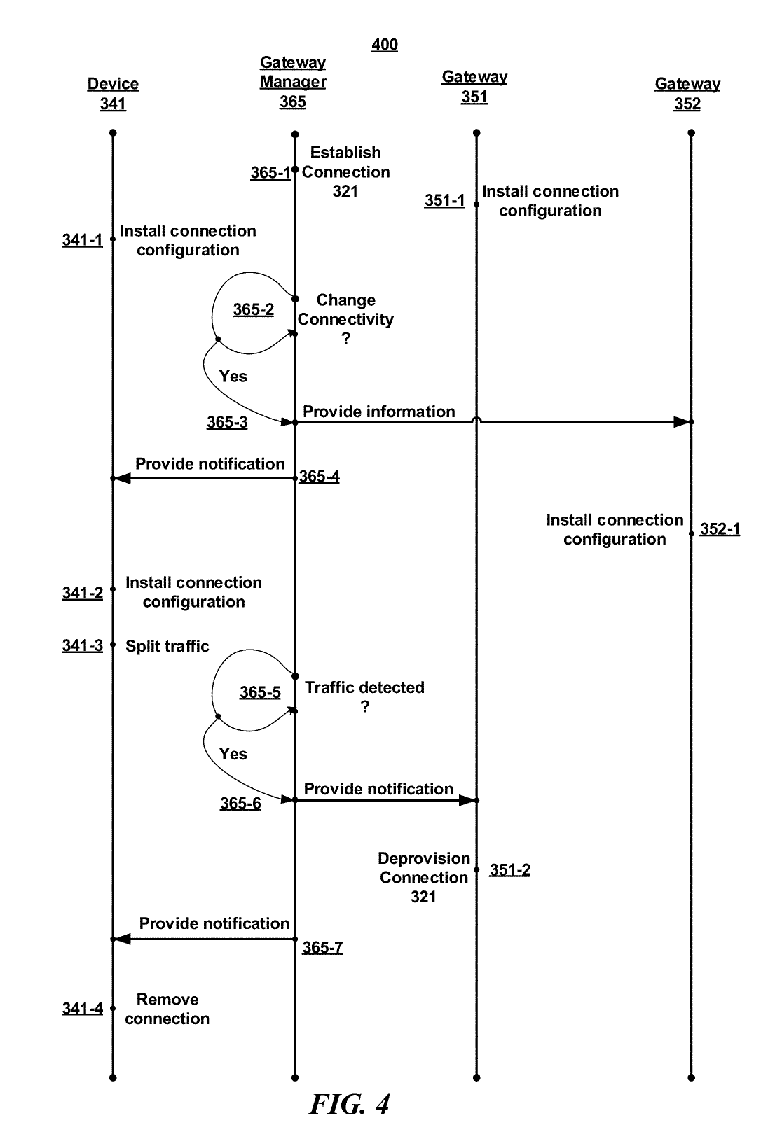

Some examples of computing device 200 include at least one storage memory (e.g. data storage memory 250), at least one operating memory (e.g., operating memory 220) and at least one processor (e.g., processing unit 210) that are respectively adapted to store and execute processor-executable code that, in response to execution, enables computing device 200 to perform actions, such as, in some examples, the actions of process 490 of FIG. 4, as discussed in greater detail below.

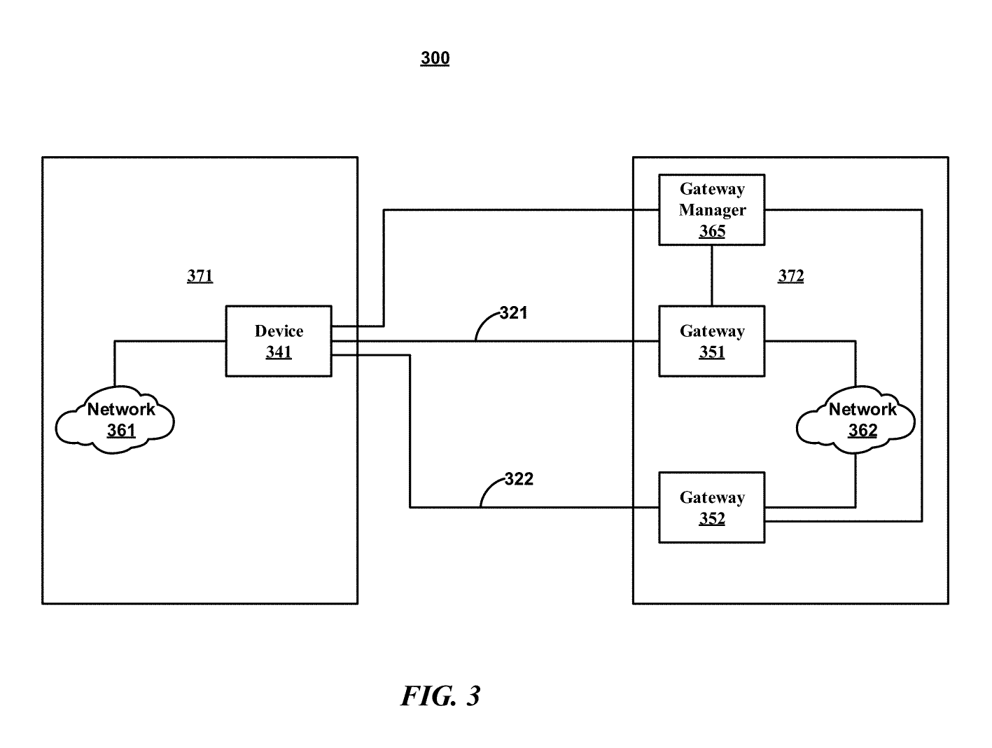

FIG. 3 is a block diagram illustrating an example of a system (300) for concurrent VPN. System 300 may include site 371 and site 372. Site 371 may include device 341 and private network 361. Site 372 may include gateway 351, gateway 352, private network 362, and gateway manager 365. In some examples, site 371 and site 372 may have one or more site-to-site VPN connection between them, such as VPN connection 321 and/or VPN connection 322.

In some examples, private network 361 is at site 371, and private network 362 is at site 372. In some examples, site 372 is remote from site 371. In some examples, each separate site is a site of a separate branch office of an organization. In some examples, device 341 is at site 371, and is configured to communicate with private network 361 at site 371. In some examples, device 341 is configured to communicate over a network via VPN connectivity achieved via a site-to-site VPN connection between site 371 and site 372 (e.g., via VPN connection 321 and/or VPN connection 322). In some examples, device 341 is a gateway for site 371 that acts as an interface between multiple other devices on site 371 and site 372 via the VPN connectivity between site 371 and site 372.

In some examples, each of the gateways, such as gateway 351 and gateway 352, is configured to enable devices at a site remote from site 372, such as device 341 at site 371, communication with private network 362 at site 371, so that one cohesive network including private network 361 and 362 can be shared as if it were one cohesive private network accessible to device 341. In some examples, each gateway at site 372 has a specific virtual IP. While gateway 351 and 352 are each on the same site, in some examples, gateway 352 is different than 351 in one or more ways. For instance, in some examples, at least a portion of a wide area network connection between gateway 351 and device 341 is different than at least a portion of the wide area network connection between gateway 351 and the device 341. For instance, in some examples, gateway 352 is not in the physical vicinity of gateway 351, and in some examples, gateway 352 is on a different fabric than gateway 351. In various examples, gateway 351 and gateway 352 may be physically separated from each other, may be on different networks, may be on different fabrics (i.e., different integrated circuits) from each other, may have distinct properties, and/or may be otherwise distinct from each other, and in some examples may be entirely distinct except based on their management by gateway manager 345 and that they both provide access to private network 362. In this way, a switch in VPN connectivity between site 371 and 372 from first VPN connection 321 to second VPN connection 322 may provide a different set of capabilities based on the distinct properties that may be present in gateway 352 relative to gateway 351.

Gateway manager 365 may be configured to manage gateways for site 372 such as gateway 351 and gateway 352, including managing site-to-site VPN connections, and configurations for such site-to-site-VPN connections. In some examples, gateways such as gateway 351 and 352 are gateway instances that are managed by gateway manager 365, including functions such as provisioning new gateway instances and provisioning new VPN connections when needed. In some examples, gateways such as gateway 351 and gateway 352 are part of a pool of gateways managed by gateway manager 365.

FIG. 3 will be further discussed in conjunction with FIG. 4.

### Illustrative Process

For clarity, the processes described herein are described in terms of operations performed in particular sequences by particular devices or components of a system. However, it is noted that other processes are not limited to the stated sequences, devices, or components. For example, certain acts may be performed in different sequences, in parallel, omitted, or may be supplemented by additional acts or features, whether or not such sequences, parallelisms, acts, or features are described herein. Likewise, any of the technology described in this disclosure may be incorporated into the described processes or other processes, whether or not that technology is specifically described in conjunction with a process. The disclosed processes may also be performed on or by other devices, components, or systems, whether or not such devices, components, or systems are described herein. These processes may also be embodied in a variety of ways. For example, they may be embodied on an article of manufacture, e.g., as processor-readable instructions stored in a processor-readable storage medium or be performed as a processor-implemented process. As an alternate example, these processes may be encoded as processor-executable instructions and transmitted via a communications medium.

FIG. 4 is a diagram illustrating a dataflow for a system (400) that may be employed as an example of system 300 of FIG. 3. In some examples, system 400 includes device 341, gateway 351, gateway 352, and gateway manager 365.

In the illustrated example, step 365-1 occurs first. At step 365-1, in some examples, gateway manager 365 manages establishing a first VPN connection (321) from device 341 to gateway 351. Step 365-1 may include communications with device 341 and gateway 351, such as communication of one VPN connection configuration to gateway 351, and causing another VPN connection configuration to be communicated to device 341. Each of the connections configurations may include a tuple in some examples. Any suitable authentication and encryption protocol may be used for the VPN communication, such as Internet Protocol security (IPsec) in some examples. Establishing the first VPN connection may include providing VPN information to gateway 351, where the VPN information may include, for examples, secrets to be used for establishing a secure tunnel connection between gateway 351 and device 341. In some examples, the VPN information may include a VPN connection configuration. In some examples, the VPN connection configuration may include a VPN tuple. In some examples, the VPN connection configuration includes IPsec parameters or the like. The VPN connection configuration may include, for example, a prefix, a shared secret (e.g., a shared secret key or a certificate), a perfect forward secrecy (PFS) value, a Diffie-Hellman (DH) value, a security association (SA) value, and or the like. In some examples, the VPN information may also include border gateway protocol (BGP) settings, which may include, in some examples, an autonomous system number (ASN), a peer IP, and/or the like. In some examples, gateway manager 365 may determine some of the VPN information via communication with site 371. Gateway manager 365 may also manage device 341 obtaining configuration information to make the connection, including the virtual IP address of gateway 351.

As shown, step 351-1 occurs next in some examples. At step 351-1, in some examples, gateway device 351 installs a VPN connection configuration on gateway device 351. As show, step 341-1 occurs next in some examples. At step 341-1, in some examples, device 341 installs another VPN connection configuration on device 341. In some examples, after a VPN connection configuration has been installed in both device 341 and gateway 351, first VPN connection 321 is operable.

As shown, decision block 365-2 occurs next in some examples. At decision block 365-2, in some examples, gateway manager 365 makes a determination as to whether a change is to be made in the VPN connectivity from site 371 to site 372. In some examples, the customer (e.g., the user site 361) decides to make a change in the VPN connection from site 371 to site 372, a communication is made to gateway manager 365 indicating the intent to change the VPN connection, and gateway determines to make a change in the VPN connection based on the communication. In some examples, the customer may wish to change the VPN connection in order to increase the number of tunnels, for higher bandwidth, to use a capability that is not present in gateway 351, for improved quality of service (QoS), or for some other reason.

In some examples, gateway manager 365 monitors first VPN connection 321 to determine whether a resource limit is being approached, such as a bandwidth limit, a limit on the number of tunnels, or the like. In some examples, gateway 362 is greater in at least one resource (e.g., bandwidth, number of tunnels, and/or the like) than gateway 351, or has at least one capability that gateway 351 lacks. In some examples, if the determination at decision block 365-2 is negative, the process remains at decision block 365-2 until the determination is positive. In some examples, if the determination at decision block 365-2 is positive, the process proceeds to step 365-3.

At step 365-3, in some examples, gateway manager 365 provides VPN information to gateway 352. In some examples, gateway 351 and gateway 352 are gateway instances, and gateway manager 365 provisions gateway 352 as a new gateway instance and provides the new gateway instance gateway 352 with VPN information. In some examples, the VPN information includes information that is associated with a second VPN connection (322) to be established between device 341 and the gateway 352. In some examples, the VPN information may be similar to VPN information provided to gateway 351 at step 365-1, except that the VPN information at step 365-3 is for second VPN connection 322 rather than first VPN connection 321. In some examples, at least a portion of a wide area network connection between gateway 351 and the device 341 is different than at least a portion of the wide area network connection between the gateway 351 and device 341. In some examples, step 365-3 occurs automatically without any manual invention.

As shown, step 365-4 occurs next in some examples. At step 365-4, in some examples, gateway manager 365 notifies device 341 of second VPN connection 322 to be established. Gateway manager 365 may also manage device 341 obtaining configuration information to make the connection, including the virtual IP address of gateway 362. In some examples, gateway manager 365 causes the configuration information to be communicated to device 341. In some examples, the configuration information includes another VPN connection configuration. In some examples, management of device 341 obtaining the configuration information is handled at site 371, and device 341 obtains the configuration information in some manner after receiving the notification at step 365-4—the manner in which device 341 obtains the configuration may be different in different examples. In some examples, device 341 downloads the configuration information after receiving the notification at step 365-4.

As shown, step 352-1 occurs next in some examples. At step 352-1, in some examples, gateway device 352 installs a VPN connection configuration on gateway device 352. As show, step 341-2 occurs next in some examples. At step 341-2, in some examples, device 341 installs another VPN connection configuration on device 341. In some examples, after a VPN connection configuration has been installed in both device 341 and gateway 351, second VPN connection 322 is operable.

As shown, step 341-3 occurs next in some examples. At step 341-3, in some examples, while the first VPN connection 321 and second VPN connection 322 are both operable, device 341 divides traffic between first VPN connection 321 and second VPN connection 322 in some fashion. In some examples, while the first and second VPN connection are both operable, device 341 splits traffic between first VPN connection 321 and second VPN connection 322 according to an equal cost multi-path (ECMP) strategy. In other examples, while the first and second VPN connection are both operable, device 341 splits traffic between first VPN connection 321 and second VPN connection 322 in another suitable manner.

As shown, decision block 365-5 occurs next in some examples. At decision 365-5, in some examples, gateway manager 365 detects/makes a determination as to whether network traffic is flowing over second VPN connection 322. In some examples, gateway 365 monitors network traffic on second VPN connection 322 to make the determination. In some examples, if network traffic has not been detected flowing over second VPN connection 322, the process remains at decision block 365-5 until network traffic is detected. In some examples, if network traffic is detected, the process proceeds to step 365-6.

At step 365-6, in some examples, in response to detecting that the network traffic is flowing between the first device and the second gateway, gateway manager 365 sends a notification to gateway 351 for the gateway 351 to deprovision first VPN connection 321. In some examples, responsive to the notification, gateway 351 deprovisions first VPN connection 321, so that first VPN connection 321 is no longer operational, and the network traffic from site 371 to site 372 now all flows through second VPN connection 322. As shown, step 351-2 occurs next in some examples. At step 351-2, in some examples, gateway 351 deprovisions first VPN connection 321 responsive to the notification from gateway manager 365. As shown, step 365-7 occurs next in some examples. At step 365-7, in some examples, in gateway manager 365 notifies device 341 to remove first VPN connection 321. As shown, step 341-4 occurs next in some examples. At step 341-4, device 341 removes first VPN connection 321 responsive to the notification from gateway manager 365. The process may then proceed to a return block, where other processing is resumed.

Examples of process 480 may enable a change in VPN the VPN connection between site 371 and site 372 from one gateway to another in site 372, where each gateway has a unique IP endpoint, without causing any disruptions or downtime. In some examples, gateway manager 365 causes the provisioning of second VPN connection 322 (the site-to-site VPN connection between device 341 and gateway 351) while keeping first VPN connection 321 provisioned as well. In some examples, gateway manager 365 does not deprovision first VPN connection 321 until network traffic is detected on second VPN connection 322. In this way, in some examples, there is no data loss or downtime because site 371 can still connect with gateway 351 using first VPN connection 321, so that site 371 is continuously connected to at least one VPN gateway on site 372 and accordingly experiences no downtime.

FIGS. 5A-5B shows a flow diagram illustrating an example process (580), that may be performed, e.g., by gateway manager 365 of FIG. 3.

In the illustrated example, step 581 occurs first. At step 581, in some examples, gateway manager 365 manages establishing a first VPN connection (321) from device 341 to gateway 351. Step 581 may include communications with device 341 and gateway 351, such as communication of one VPN connection configuration to gateway 351, and causing another VPN connection configuration to be communicated to device 341.

As shown, decision block 582 occurs next in some examples. At decision block 582, in some examples, gateway manager 365 makes a determination as to whether a change is to be made in the VPN connectivity from site 371 to site 372. In some examples, if the determination at decision block 582 is negative, the process remains at decision block 582 until the determination is positive. In some examples, if the determination at decision block 582 is positive, the process proceeds to step 583.

At step 583, in some examples, gateway manager 365 provides VPN information to gateway 352. As shown, step 584 occurs next in some examples. At step 584, in some examples, gateway manager 365 notifies device 341 of second VPN connection 322 to be established. As shown, decision block 585 occurs next in some examples. At decision 585, in some examples, gateway manager 365 detects/makes a determination as to whether network traffic is flowing over second VPN connection 322. In some examples, if network traffic has not been detected flowing over second VPN connection 322, the process remains at decision block 585 until network traffic is detected. In some examples, if network traffic is detected, the process proceeds to step 586.

At step 586, in some examples, in response to detecting that the network traffic is flowing between the first device and the second gateway, gateway manager 365 sends a notification to gateway 351 for the gateway 351 to deprovision first VPN connection 321. As shown, step 587 occurs next in some examples. At step 587, in some examples, in gateway manager 365 notifies device 341 to remove first VPN connection 321. The process may then proceed to a return block, where other processing is resumed.

Some steps above are optional and are not performed in all examples. For instance, in some examples, step 587 is not performed, and the process goes directly from step 586 to the return block.

### CONCLUSION

While the above Detailed Description describes certain examples of the technology, and describes the best mode contemplated, no matter how detailed the above appears in text, the technology can be practiced in many ways. Details may vary in implementation, while still being encompassed by the technology described herein. As noted above, particular terminology used when describing certain features or aspects of the technology should not be taken to imply that the terminology is being redefined herein to be restricted to any specific characteristics, features, or aspects with which that terminology is associated. In general, the terms used in the following claims should not be construed to limit the technology to the specific examples disclosed herein, unless the Detailed Description explicitly defines such terms. Accordingly, the actual scope of the technology encompasses not only the disclosed examples, but also all equivalent ways of practicing or implementing the technology.

We claim:

1. An apparatus, comprising:
a device including at least one memory adapted to store run-time data for the device, and at least one processor that is adapted to execute processor-executable code that, in response to execution, enables the device to perform actions, including:
determining that a change is to be made in virtual private network (VPN) connectivity between a first site and a second site while a first VPN connection is operational between a first device at the first site and a first gateway at the second site;
providing a VPN connection configuration to a second gateway at the second site, the VPN connection configuration including information that is associated with a second VPN connection to be established between the first device and the second gateway, wherein at least a portion of a wide area network connection between the first gateway and the first device is different than at least a portion of the wide area network connection between the second gateway and the first device;
detecting, via monitoring the second VPN connection, that network traffic is flowing over the second VPN connection between the first device and the second gateway; and
in response to detecting that the network traffic is flowing between the first device and the second gateway, sending a notification to the first gateway for the first gateway to deprovision the first VPN connection.

2. The apparatus of claim 1, the actions further including:
after providing the VPN connection configuration to the second gateway, communicating, to the first device, a notification that is associated with the second VPN connection to be established between the first device and the second gateway.

3. The apparatus of claim 1, the actions further including:
after sending the notification to the first gateway for the first gateway to deprovision the first VPN connection, sending to the first device a notification of the deprovisioning of the first VPN connection.

4. The apparatus of claim 1, wherein the first site includes multiple other devices, and wherein first device is a gateway for the first site that is configured to act as an interface between the multiple other devices and the second site via the VPN connectivity between the first site and the second site.

5. The apparatus of claim 1, wherein the VPN connection configuration includes Internet Protocol Security (IPsec) parameters.

6. A method, comprising:
determining that a change is to be made in virtual private network (VPN) connectivity between a first site and a second site while a first VPN connection is operational between a first device at the first site and a first gateway at the second site;
communicating VPN information to a second gateway at the second site, the VPN information including information that is associated with a second VPN connection to be established between the first device and the second gateway;
determining that network traffic is flowing over the second VPN connection between the first device and the second gateway; and
via at least one processor, responsive to determining that the network traffic is flowing between the first device and the second gateway, instructing the first gateway to deprovision the first VPN connection.

7. The method of claim 6, further comprising:
after communicating the VPN information to the second gateway, communicating, to the first device, a notification that is associated with the second VPN connection to be established between the first device and the second gateway.

8. The method of claim 6, further comprising:
after sending the notification to the first gateway for the first gateway to deprovision the first VPN connection, sending to the first device a notification of the deprovisioning of the first VPN connection.

9. The method of claim 6, wherein the first site includes multiple other devices, and wherein first device is a gateway for the first site that is configured to act as an interface between the multiple other devices and the second site via the VPN connectivity between the first site and the second site.

10. The method of claim 6, wherein the method is performed in a gateway manager for the second site.

11. The method of claim 6, further comprising:
after the second VPN connection is established, the first device dividing network traffic between the first gateway and the second gateway.

12. The method of claim 11, wherein dividing network traffic between the first gateway and the second gateway is accomplished via Equal Cost Multi-Path (ECMP) routing.

13. The method of claim 6, wherein the VPN information includes a first tuple.

14. The method of claim 13, wherein the first tuple includes Internet Protocol Security (IPsec) parameters.

15. The method of claim 13, further comprising:
causing a second tuple to be communicated to the first device.

16. The method of claim 15, further comprising:
installing the first tuple in the second gateway; and
installing the second tuple in the first device, wherein the second VPN connection is established responsive to the first tuple being installed in the second gateway and the second tuple being installed in the first device.

17. A processor-readable storage medium, having stored thereon processor-executable code that, upon execution by at least one processor, enables actions, comprising:
responsive to a determination that a change is to be made in virtual private network (VPN) connectivity between a first site and a second site while a first VPN connection is operational between a first device at the first site and a first gateway at the second site, sending configuration information to a second gateway at the second site, the configuration information including information that is associated with a second VPN connection to be established between the first device and the second gateway;
detecting that network traffic is flowing over the second VPN connection between the first device and the second gateway; and
in response to detecting that the network traffic is flowing between the first device and the second gateway, communicating a notification to the first gateway for the first gateway to deprovision the first VPN connection.

18. The processor-readable storage medium of claim 17, the actions further comprising:
after providing the configuration information to the second gateway, communicating, to the first device, a notification that is associated with the second VPN connection to be established between the first device and the second gateway.

19. The processor-readable storage medium of claim 17, wherein the first site includes multiple other devices, and wherein first device is a gateway for the first site that is configured to act as an interface between the multiple other devices and the second site via the VPN connectivity between the first site and the second site.

20. The processor-readable storage medium of claim 17, the actions further comprising:
after communicating the notification to the first gateway for the first gateway to deprovision the first VPN connection, communicating to the first device a notification of the deprovisioning of the first VPN connection.
